(19) United States
(12) Patent Application Publication
(10) Pub. No.: US 2015/0278882 A1
(43) Pub. Date: Oct. 1, 2015

(54) ONLINE ADVERTISEMENT SYSTEM AND ONLINE ADVERTISEMENT METHOD

(71) Applicant: INDUSTRY-ACADEMIC COOPERATION FOUNDATION, YONSEI UNIVERSITY, Seoul (KR)

(72) Inventors: Da Young Ju, Incheon (KR); Yu Min Shin, Seoul (KR)

(21) Appl. No.: 14/438,432

(22) PCT Filed: Dec. 20, 2012
(86) PCT No.: PCT/KR2012/011184

§ 371 Date: Apr. 24, 2015

(30) Foreign Application Priority Data
Oct. 26, 2012 (KR) 10-2012-0119847

(51) Int. Cl. G06Q 30/02

(52) U.S. Cl. CPC G06Q 30/0277; G06Q 30/0273; G06Q 30/0246

(57) ABSTRACT

An online advertising system is provided. The method includes: a first client who provides advertisement content, a server which receives and stores an advertisement content, and a second client who provides image content to server and selects an advertisement content that is to be merged with image content, wherein server generates merged content by merging image content with an advertisement content, provides merged content to a third client, and converts merged content into advertisement content when third client clicks on a predetermined area in merged content.

### TECHNICAL FIELD

The present invention relates to an online advertising system and method, and more particularly, to an online advertising system and method which can improve advertising efficiency by merging a user's image content with advertisement content.

### BACKGROUND ART

A social network service is basically about providing a networking service by expanding offline acquaintance relationships among users to an online space. The social network is becoming the most active online space for users among Internet services. In particular, a recent increase in the influence of social networks represented by Facebook and Twitter is even changing the media environment to an interactive one. Therefore, these services are collectively referred to “social media” and are characterized by network-based multidirectional communication.

As the mobile environment expands, the “social media” is growing sharply. According to statistical results, Facebook, a major social network service, began to grow dramatically after the emergence of the smartphone environment. With the rapid popularization of smartphones after the introduction of iPhone, people can access the Internet or World Wide Web (WWW) for a longer period of time through mobile devices, and online experience that was possible only at desks has begun to be available in all daily activities (e.g., while on the move) through the mobile devices. Accordingly, as of August 2012, the use of the “social media” (such as Facebook and Twitter) through mobile devices occupies more than half of the total use of the social media.

To cope with this new media environment, advertisers are expanding online advertisements for consumers and expecting an effective advertising effect. Accordingly, platform companies (such as Facebook and Twitter) which provide social network services are diversifying and expanding advertisement models in order to satisfy potential consumers within social network spaces as well as advertisers.

However, current forms of advertising in social networks have limitations. While most users use social network services through mobile devices, advertisement models of platform businesses which provide these services are still based on desktop browsers. Although Facebook started to place mobile advertisements, it is getting a negligible effect. Typical forms of online advertising include posting a “display advertisement” in a web page, providing a context advertisement in a search engine result page, and e-mail marketing which includes sending spam e-mails. These forms of online advertisements have been displayed on a desktop browser having a wide display space, together with content. However, as user experience is becoming centered on mobile devices, the current forms of online advertisements cannot be fully displayed on a mobile device without disturbing the user experience due to a small display space of the mobile device.

The majority of mobile advertisements placed outside social media spaces are also display advertisements on small browsers or search advertisements within user experience. Since these advertisements are not organically combined with user experience, they are still considered as annoying content. These advertisements cause users to leave, and the effect of the advertisements is reduced. Thus, these forms of advertisements are not suitable for advertisers and potential customers (A representative example is Myspace which experienced a reduction in users due to advertisements). To solve this problem, Facebook and Twitter, major social media spaces of today, are focusing on targeted advertising. Targeted advertising is targeted marketing based on interests of users, and targeted advertisements are exposed only to users close to the type of potential customers set by an advertiser in order to increase the advertising effect for potential customers.

Advertisers are targeting a social media space as a new advertisement area that has evolved from a conventional online advertisement area. However, the current forms of advertisements provided by social network platforms are not organically combined with users' social media content not only on desktops but also on mobile devices, and most users' unwillingness to view these advertisements is serving as a hindrance to the advertising effect. This situation not only reduces the advertising effect for potential customers but also poses a risk to platform businesses in maintaining services.

In an example, when a user uses a social network service using a mobile device, a display advertisement may be posted on a portion of the screen, or an advertisement may be popped up as a recommendation within the media space. However, even such advertisements are different from the experience the user has been having in the social media space.

Facebook and Twitter are trying to reduce the inconvenience of potential customers by provides an user-targeted advertisements having same design with other contents to customers. However, from the perspective of users, since these advertisements consist of direct and indirect promotions by an advertiser instead of interactions with acquaintances in the individual media space, the effect of the advertisements is not clear, and the accuracy of targeting is not high because the context the users are in is not fully reflected.

As more people use social network services, it is more advantageous to platform businesses. However, since content in individual social media spaces is not yet organically combined with advertisement content provided by platform service providers, the advertising effect is low, and users are likely to turn away from platform services.

### DISCLOSURE

### Technical Problem

Aspects of the present invention provide an online advertising system and method which can maximize the effect of advertisements using an online service, in particular, a social network service.

Aspects of the present invention also provide an online advertising system and method which can expose advertisements to users who are viewing online content while minimizing the users' feeling of repulsion.

Aspects of the present invention also provide an online advertising system and method which make active propagation possible by providing a portion of an advertising fee to a user who provided content.

However, aspects of the present invention are not restricted to the one set forth herein. The above and other aspects of the present invention will become more apparent to one of ordinary skill in the art to which the present invention pertains by referencing the detailed description of the present invention given below.

### Technical Solution

One or more exemplary embodiments provide a first client who provides advertisement content, a server which receives and stores the advertisement content and a second client who provides image content to the server and selects the advertisement content that is to be merged with the image content, wherein the server generates merged content by merging the image content with the advertisement content, provides the merged content to a third client, and converts the merged content into the advertisement content when the third client clicks on a predetermined area in the merged content.

One or more exemplary embodiments provide wherein the server generates a thumbnail image corresponding to the advertising content, and the thumbnail image is placed in the image content to form the merged content.

One or more exemplary embodiments provide wherein the predetermined area corresponds to an area in which the thumbnail image is placed.

One or more exemplary embodiments provide wherein billing information is generated when the third client clicks on the predetermined area, and a portion of an advertising fee is provided from the first client to the second client based on the billing information.

One or more exemplary embodiments provide wherein when storing the advertisement content, the server generates an advertisement content list comprising advertiser information, keyword information and tag information of the advertisement content.

One or more exemplary embodiments provide wherein the second client selects the advertisement content that is to be merged with the image content by searching the advertisement content list.

One or more exemplary embodiments provide wherein the server analyzes the image content and provides the second client with a list of recommended advertisement content arranged in order of relevance to the image content based on the advertisement content list.

One or more exemplary embodiments provide wherein the server provides the first client with statistical data comprising the number of exposures of the advertisement content and the number of clicks on the merged content.

One or more exemplary embodiments provide a first client who provides advertisement content, a server which receives and stores the advertisement content and a second client who provides image content to the server and selects the advertisement content that is to be merged with the image content, wherein the server generates merged content by merging the image content with the advertisement content and provides the merged content to a third client, billing information is generated when the third client views the merged content, and a portion of an advertising fee is provided from the first client to the second client based on the billing information.

One or more exemplary embodiments provide wherein the server generates a thumbnail image corresponding to the advertisement content, and the thumbnail image is placed in the image content to form the merged content.

One or more exemplary embodiments provide wherein the merged content is converted into the advertisement content when the third client clicks on a predetermined area in the merged content.

One or more exemplary embodiments provide wherein when storing the advertisement content, the server generates an advertisement content list comprising advertiser information, keyword information and tag information of the advertisement content.

One or more exemplary embodiments provide wherein the second client selects the advertisement content that is to be merged with the image content by searching the advertisement content list.

One or more exemplary embodiments provide wherein the server analyzes the image content and provides the second client with a list of recommended advertisement content arranged in order of relevance to the image content based on the advertisement content list.

One or more exemplary embodiments provide wherein the server provides the first client with statistical data comprising the number of exposures of the advertisement content and the number of clicks on the merged content.

One or more exemplary embodiments provide receiving and storing advertisement content, receiving image content that is to be merged with advertisement content selected from the advertisement content, generating merged content by merging the image content with the selected advertisement content and providing the merged content to a client who requested the merged content.

One or more exemplary embodiments provide wherein the merged content is converted into the advertisement content when the client clicks on a predetermined area of the merged content.

One or more exemplary embodiments provide wherein the generating of the merged content comprises generating a thumbnail image corresponding to the advertisement content and placing the thumbnail image in the image content, wherein the predetermined area corresponds to the thumbnail image.

One or more exemplary embodiments provide wherein the storing of the advertisement content comprises generating an advertisement content list comprising advertiser information, keyword information and tag information of the advertisement content.

One or more exemplary embodiments provide further comprising analyzing the image content and providing a list of recommended advertisement content arranged in order of relevance to the image content based on the advertisement content list.

### Advantageous Effects

According to the present invention, since a user's content, in particular, image content is combined with advertisement content, the user's feeling of repulsion to the advertisement content can be reduced. In addition, the user himself or herself selects advertisement content that matches content uploaded by the user. Therefore, advertisements unwanted by the user can be excluded, whereas advertisements wanted by the user are placed.

Furthermore, advertisement content is placed in image content in the form of a small image, for example, a thumbnail image. Thus, a feeling of repulsion to an advertisement can be reduced. When a user clicks on the small image while viewing the image content, the image content is converted into the advertisement content, thereby maximizing the advertising effect. Also, a portion of an advertising fee paid per click by an advertiser is provided to a user who posted the advertisement. Therefore, users are motivated to post image content together with advertisement content of the advertiser.

However, the effects of the present invention are not restricted to the one set forth herein. The above and other effects of the present invention will become more apparent to one of daily skill in the art to which the present invention pertains by referencing the claims.

### DESCRIPTION OF DRAWINGS

The above and other aspects and features of the present invention will become more apparent by describing in detail exemplary embodiments thereof with reference to the attached drawings, in which:

FIG. 1 is a schematic block diagram of an online advertising system according to an embodiment of the present invention;

FIGS. 2 through 8 are diagrams illustrating the advertising sequence of the online advertising system of FIG. 1;

FIGS. 9 through 12 are diagrams illustrating the configuration of a server included in the online advertising system of FIG. 1;

FIGS. 13 and 14 are diagrams illustrating configurations of an advertisement content list provided by the server included in the online advertising system of FIG. 1;

FIGS. 15 through 17 illustrate a client screen on which advertisement content of the online advertising system of FIG. 1 is placed;

FIGS. 18 and 19 illustrate an actual client screen on which advertisement content of the online advertising system of FIG. 1 is placed; and

FIG. 20 is a flowchart illustrating an online advertising method according to an embodiment of the present invention.

### MODE FOR INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

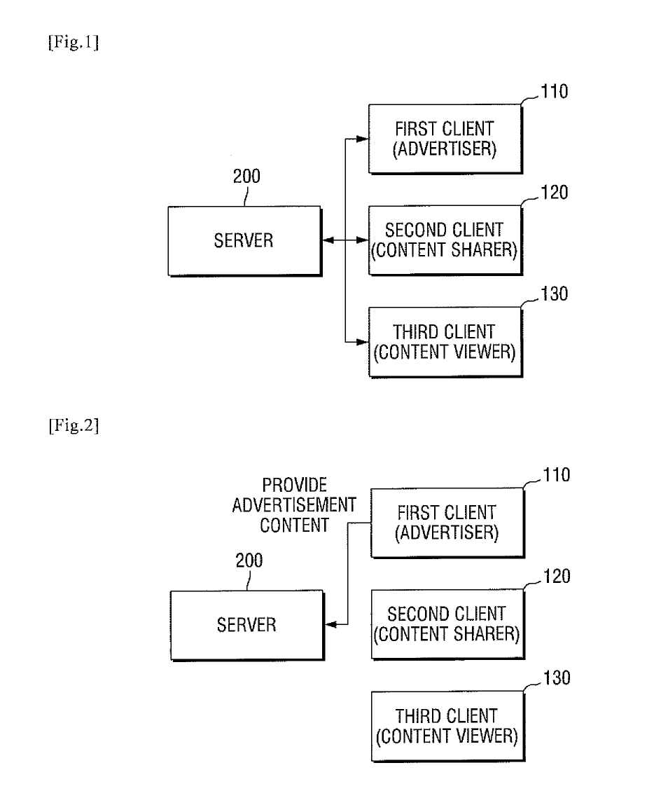

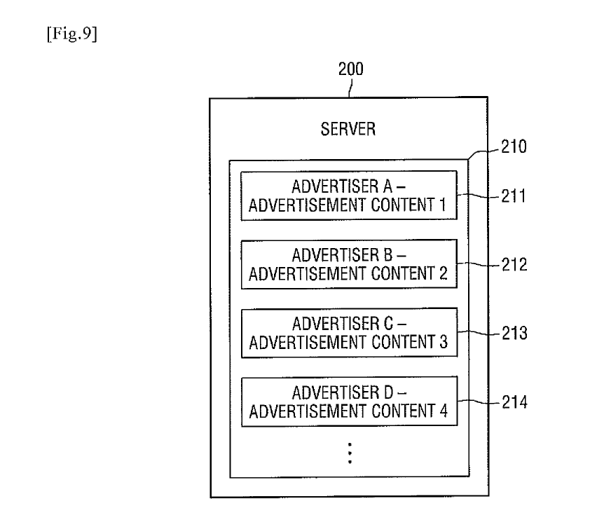

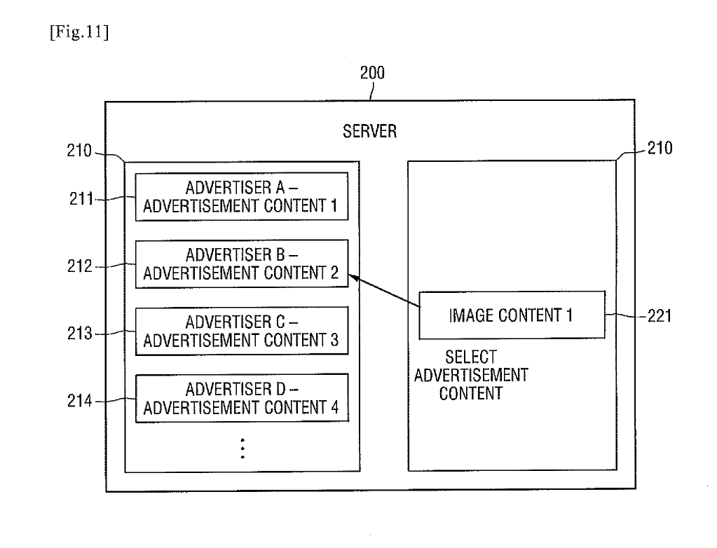

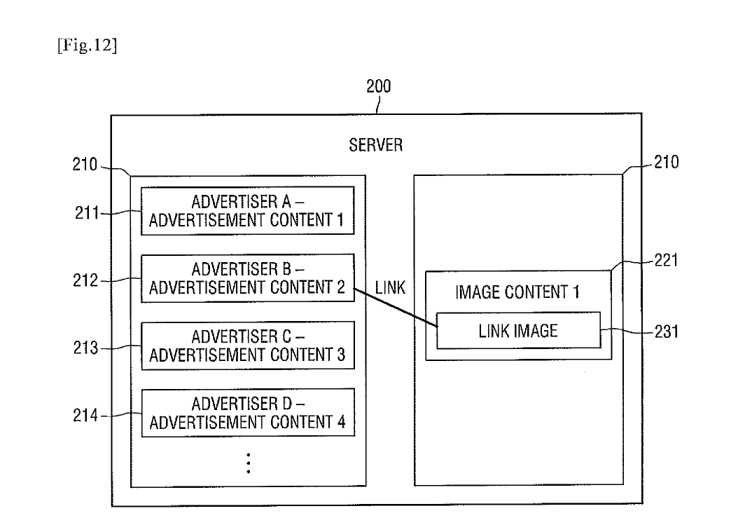

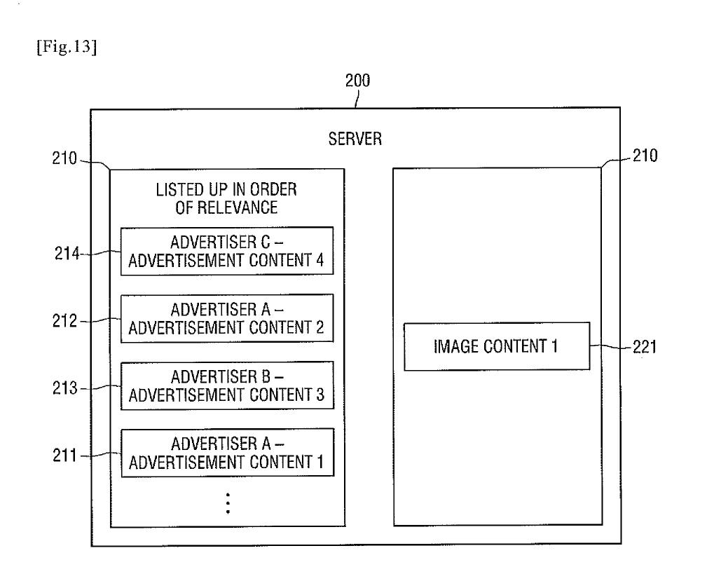

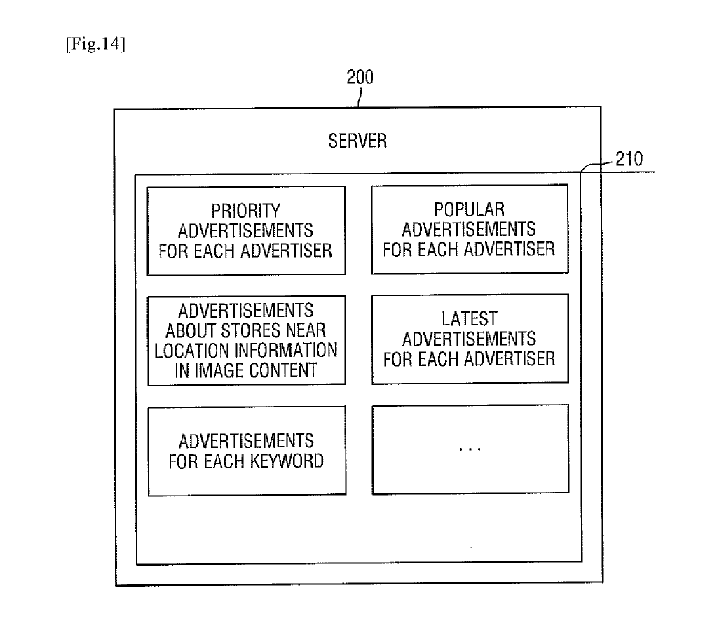

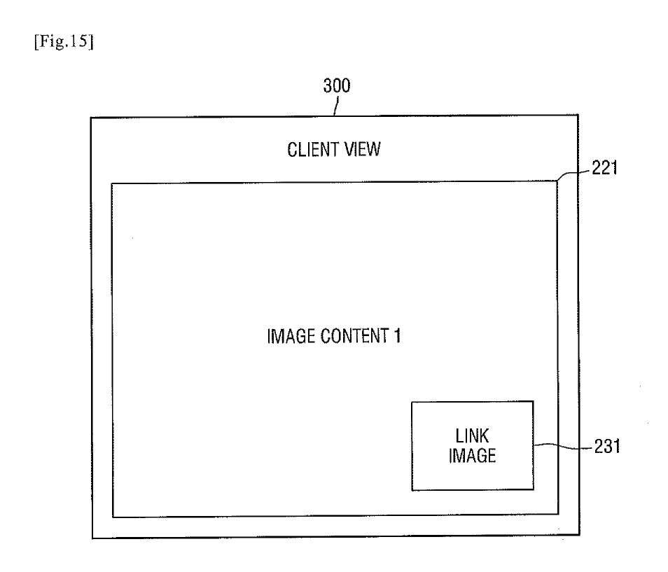

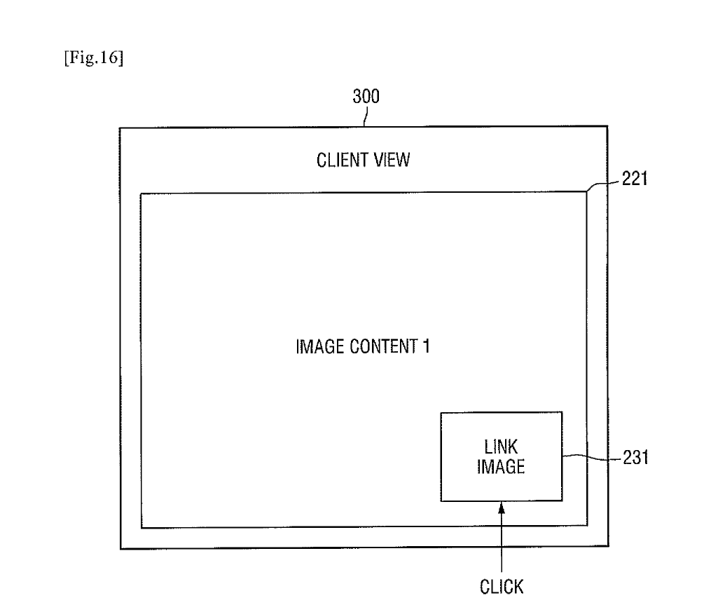

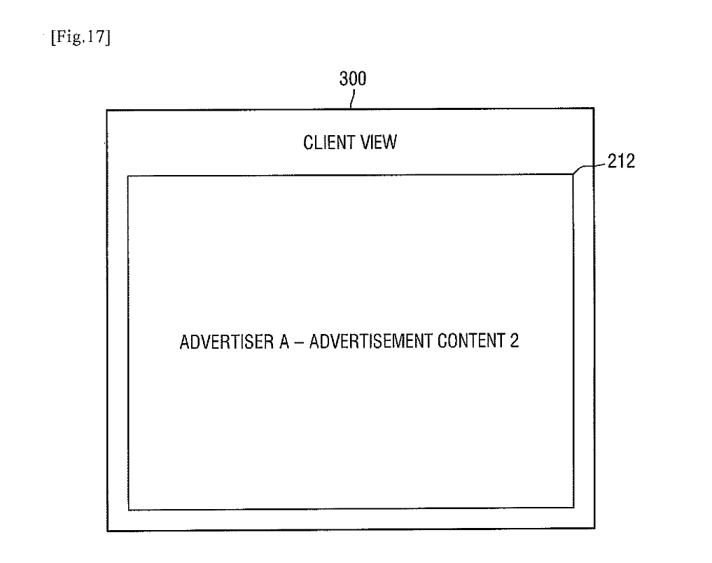

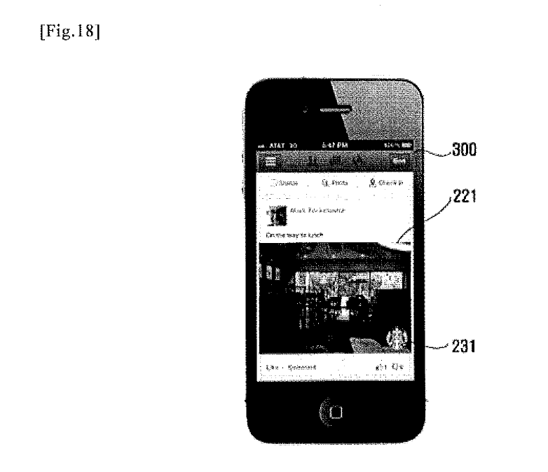

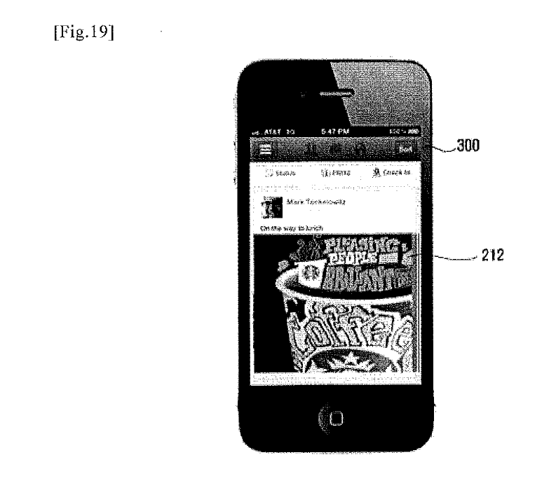

An online advertising system according to an embodiment of the present invention will now be described with reference to FIGS. 1 through 19. FIG. 1 is a schematic block diagram of an online advertising system according to an embodiment of the present invention. FIGS. 2 through 8 are diagrams illustrating the advertising sequence of the online advertising system of FIG. 1. FIGS. 9 through 12 are diagrams illustrating the configuration of a server included in the online advertising system of FIG. 1. FIGS. 13 and 14 are diagrams illustrating configurations of an advertisement content list provided by the server included in the online advertising system of FIG. 1. FIGS. 15 through 17 illustrate a client screen on which advertisement content of the online advertising system of FIG. 1 is placed. FIGS. 18 and 19 illustrate an actual client screen on which advertisement content of the online advertising system of FIG. 1 is placed.

An online advertising system according to an embodiment of the present invention may consist of a plurality of clients (110, 120, 130) and a server 200.

Specifically, the online advertising system according to the current embodiment may include a first client 110 who provides advertisement content, the server 200 which receives and stores advertisement content, and a second client 120 who provides image content to the server 200 and selects advertisement content that is to be merged with the image content. The server 200 generates merged content by merging image content with advertisement content and provides the merged content to a third client 130. When the third client 130 clicks on a predetermined area in the merged content, the merged content is converted into the advertisement content.

The first client 110 may be an advertiser, the second client 120 may be a user (uploader) who provides content to a platform that offers an online service such as a social network service, and the third client 130 may be a user (downloader) who receives content provided by the second client 120.

Each of the first through third clients 110 through 130 can access the server 200. The server 200 may store and manage a plurality of pieces of content, e.g., image content (such as photographs) provided by a user and a plurality of pieces of advertisement content provided by an advertiser. In addition, at the request of another user, the server 200 may provide image content and/or advertisement content or provide merged content generated by merging the image content with the advertisement content.

For example, the server 200 may be an SNS server which provides a social network service. However, the server 200 is not limited to the SNS server and may also be a platform (e.g., an online bulletin board server) which enables specific content to be registered and/or queried online or a server which provides any other online platform.

A plurality of clients can access the server 200 and freely register/query content. However, content may also be allowed to be exchanged only among relevant users.

The first client 110 may provide one or more pieces of advertisement content. The first client 110 may freely register or view content other than advertisement content provided on a given platform. Advertisement content may denote all forms of content that represent a particular product. For example, the advertisement content may include a product image as well as all content that directly and indirectly describe the product. The first client 110 (i.e., an advertiser) may store advertisement content in the server 200 and pay a predetermined advertising fee to the server 200 when the advertisement content is viewed, exposed to other users, or clicked. As will be described later, when the advertising fee is incurred, a predetermined percentage of the advertising fee may be provided to another user (e.g., the second client 120) who posted the advertisement content.

That is, in some other embodiments, even if the third client 130 does not click on merged content, when the third client 130 views the merged content, billing information may be generated immediately. Based on the billing information, a portion of the advertising fee may be provided from the first client 110 to the second client 120.

The second client 120 may provide one or more pieces of content, for example, image content such as photographs or videos and may view content provided by other clients. The second client 120 may create multimedia content including text, images or sound or may copy created content and post the created or copied content on the same service platform provided by the server 200. In this process, the second client 120 may select advertisement content, which matches the content (in particular, image content) that he or she posted, in the server 200 and merge the selected advertisement content with the image content that he or she posted. Accordingly, another user provided with the merged content by the second client 120 may be naturally exposed to the advertisement content. In addition, since the second client 120 himself or herself selected an advertisement that matches his or her content, the relevance of the advertisement to the content is high. Thus, the advertising effect can be increased.

The third client 130 may query content provided by the second client 120. Like the second client 120, the third client 130 may provide content to the server 200 so that the second client 120 can view the content. That is, the second client 120 and the third client 130 can swap roles with each other between a content provider and a content viewer. The third client 130 can access detailed information about advertisement content by clicking on a link image or a thumbnail image of the advertisement content exposed in the process of querying or viewing merged content provided by the second client 120. In this process, the first client 110 may be charged for the advertisement.

The second client 120 and the third client 130 may have a certain relationship online depending on their intimacy level. According to a policy of the server 200 which provides a platform, clients other than the second client 120 and the third client 130 who are acquaintances may not be allowed to view content provided by the second client 120 and the third client 130.

In the example illustrated in the drawings, content provided by the second client 120 is viewed by the third client 130. However, the present invention is not limited to this example, and a plurality of other clients can also view or query corresponding merged content and/or advertisement content at the same time or different times.

Specifically, referring to FIG. 2, the first client 110 provides advertisement content to the server 200. The server 200 may have a separate storage area for an advertiser, and the advertiser, like other general users, may use a service platform provided by the server 200.

The first client 110 may upload a plurality of different pieces of advertisement content. The pieces of advertisement content may be separately managed by the server 200 and selected by the second client 120.

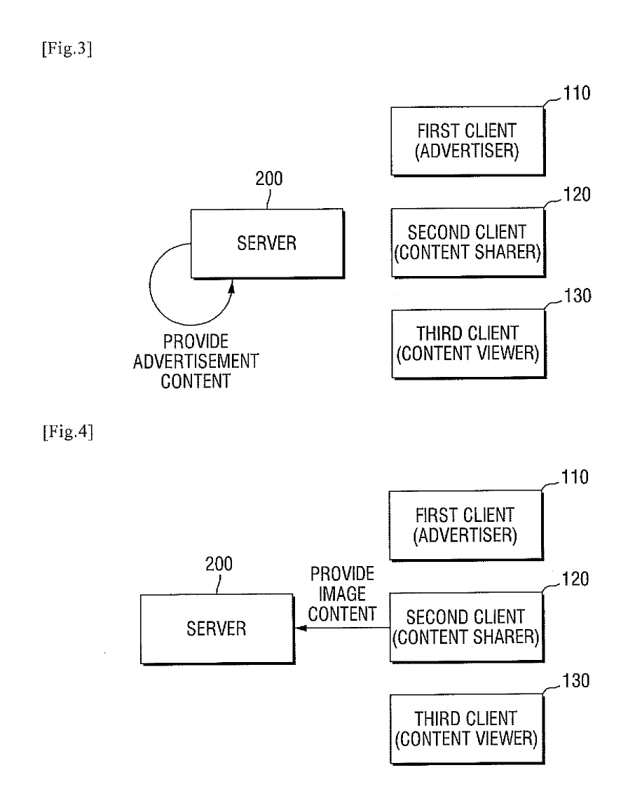

Referring to FIG. 3, the server 200 may store the uploaded advertisement content in the storage area. In this process, the first client 110 may also provide content data about the uploaded advertisement content, so that the server 200 can store the content data.

For example, when storing the advertisement content, the server 200 may also store advertisement content data including advertiser information, keyword information, tag information, product information, sales information, etc. of the advertisement content. Based on the advertisement content data, the server 200 may generate an advertisement content list including a plurality of pieces of advertisement content.

The advertisement content data may be managed by the server 200. When the second client 120 searches for advertisement content that matches his or her image content, the server 200 may determine the order of priority in view of the advertisement content data.

Referring to FIG. 4, the second client 120 who uses the service platform provided by the server 200 may generate certain image content and upload the generated image content to the server 200. The image content may include photographs or videos and all forms of electronic files that are visually recognizable. The image content may be text content that partially includes images. When the server 200 is a server that provides a social network service, the image content may be designed to show the daily life of the second client 120, send greetings, or provide information.

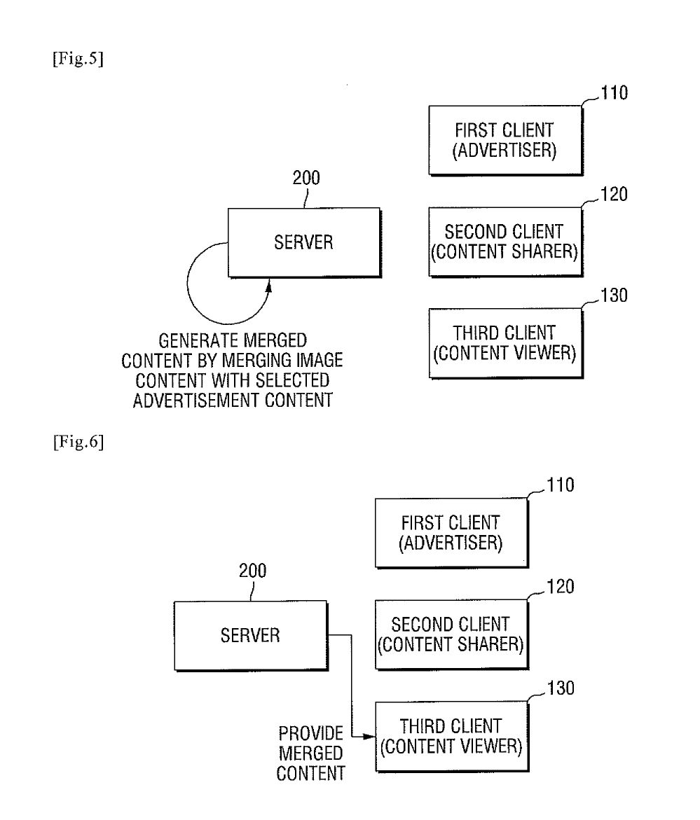

Referring to FIG. 5, merged content is generated by merging advertisement content selected from the advertisement content list of the server 200 with the uploaded image content. The process of selecting the advertisement content may be performed by the second client 120 who provided the image content. However, the present invention is not limited thereto, and the server 200 can also automatically determine advertisement content in view of the degree of matching between the image content and the advertisement content data or in view of priority. Alternatively, the server 200 may list up advertisement content in order of priority, thereby suggesting a guideline that enables the second client 120 to easily select advertisement content.

The second client 120 may select advertisement content that is to be merged with its image content before or after uploading the image content to the server 200. When the second client 120 selects advertisement content after uploading the image content, the server 200 may analyze the uploaded image content and recommend advertisement content that matches the image content. Even when selecting advertisement content before uploading the image content, the second client 120 may transmit metadata, tag information, keyword information, etc. of the image content to the server 200 in advance. Accordingly, the second client 120 may receive a recommendation about advertisement content that matches the image content from the server 200.

The server 200 may generate merged content by inserting selected advertisement content into the image content. For example, the advertisement content may be confined to less than a predetermined portion of the entire area of the image content. The server 200 may merge the image content and the advertisement content in real time. When the advertisement content is in the form of an image file, the server 200 may generate one piece of merged content by inserting the advertisement content in the form of an image file into the image content. In addition, the advertisement content may not be directly inserted into the image content. Instead, a portion of the advertisement content may be extracted and then inserted into the image content. Alternatively, a link image to the advertisement content or an image (e.g., a product's trademark, logo or thumbnail image) corresponding to the advertisement content may be generated and placed in the image content.

Referring to FIG. 6, the merged content thus generated may be provided to the third client 130, i.e., another user who uses the service platform provided by the server 200. The merged content may be provided at the request of the third client 130. When the service platform is in the form of an electronic bulletin board, the merged content may be posted and open to the public without a request.

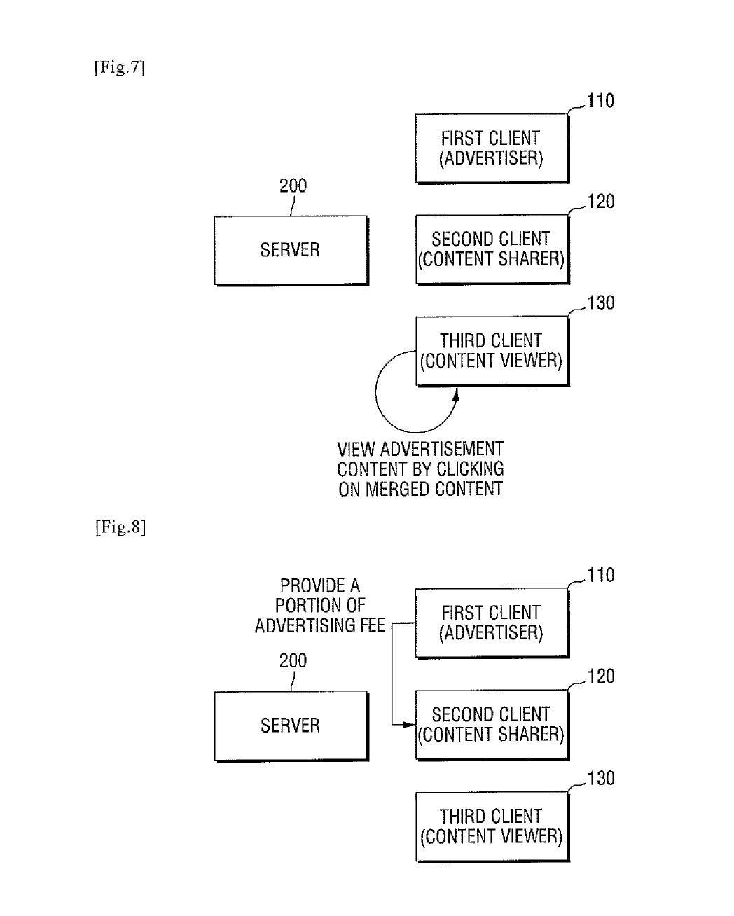

Referring to FIG. 7, when the third client 130 views merged content of interest, the merged content may be automatically converted into advertisement content at the very moment when the third client 130 clicks on part of the merged content or views the merged content. For example, the merged content may be generated by synthesizing a link image in a specific area of image content. When the third client 130 clicks on a link image of interest, the entire image content being displayed may be converted into advertisement content.

The process of displaying the advertisement content may be achieved by converting the image content directly into the advertisement content or by redirecting to a web address of the advertisement content.

Referring to FIG. 8, when the third client 130 is exposed to the advertisement content, billing information may be generated. Accordingly, an advertising fee may be provided from the first client 110 who is an owner of the advertisement content to the server 200 which is a service platform provider. Here, a portion of the adverting fee may be provided to the second client 120 who provided the advertisement content to the third client 130. For example, 70% of the total advertising fee may be provided to the server 200, and the remaining 30% may be provided to the second client 120.

In some other embodiments, after a first poster posts merged content including advertisement content, there may be a second poster who copies and posts the merged content of the first poster. In this case, an advertising fee incurred when another user clicks on or views the merged content of the second poster may be distributed in a predetermined ratio between the first poster and the second poster.

As described above, since a portion of an advertising fee incurred when advertisement content is viewed, exposed, or clicked is also provided to the second client 120 who contributed to advertising revenue, the second client 120 may be motivated to merge the advertisement content with his or her image content and induced to select efficient advertisement content that better matches the image content.

Referring to FIG. 9, the server 200 may generate and manage an advertisement content list 210 including a plurality of pieces of advertisement content 211 through 214 in a predetermined storage area. The pieces of advertisement content may have been uploaded by first clients 110 who are advertisers. The advertisers of the pieces of advertisement content may be different, or the advertisers of some pieces of advertisement content may be the same.

As described above, the advertisement content list 210 may include information about advertisers as well as keyword information, tag information, storage duration information, expiry date information, etc. of each piece of advertisement content. The server 200 may store numerous pieces of advertisement content. The server 200 may provide a search function for advertisement content, so that the second client 120 can efficiently search for and select advertisement content.

In addition, the server 200 may provide the first client 110 with advertisement related statistical data including the number of exposures of advertisement content and the number of clicks on merged content. Therefore, the first client 110 can modify an advertising strategy and manage advertisements more efficiently by referring to the advertisement related statistical data.

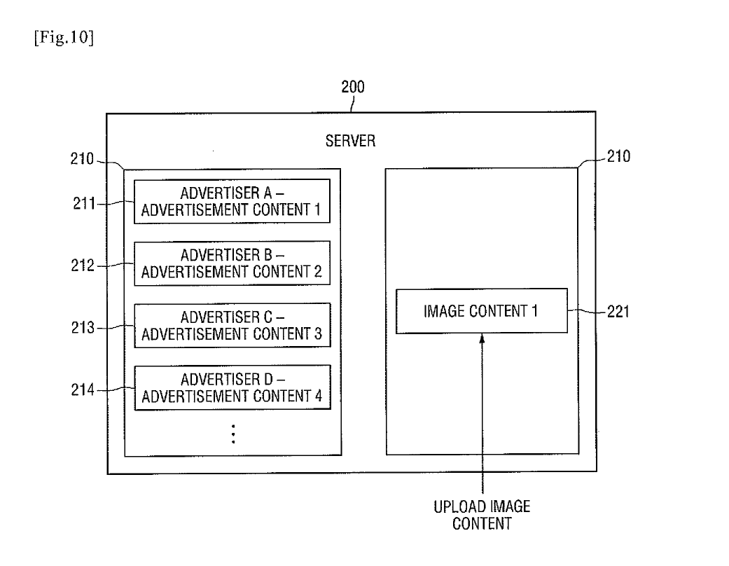

Referring to FIGS. 10 through 12, in a state where the advertisement content list 210 has been generated by the server 200, the second client 120 may upload image content 221. When the second client 120 selects advertisement content 212 that matches the image content 221 before or after uploading the image content 221, the server 200 may generate a link image 231 or a thumbnail image corresponding to the advertisement content 212 in the image content 221 and generate merged content by merging the image content 221 with the link image 231.

Referring to FIGS. 13 and 14, if the server 200 stores a plurality of pieces of advertisement content as described above, it may be difficult for a client to determine whether there exists advertisement content that matches image content that the client intends to upload or has uploaded. Therefore, the server 200 may arrange the pieces of advertisement content in order of relevance to the above image content. In this process, the server 200 may determine the order of relevance by analyzing the image content or referring to a tag of the image content or metadata information of the image content.

Therefore, the second client 120 can easily select advertisement content based on a list of recommended advertisement content arranged in order of relevance to the image content.

Alternatively, the second client 120 may search an advertisement content list to select advertisement content that is to be merged with the image content. In the advertisement content list, the second client 120 may select desired advertisement content based on various search conditions including keywords, advertiser information, categories, etc.

In addition, an advertiser may recommend advertisement content in order of his or her priority. For example, advertiser A may select a keyword or a category that matches his or her advertisement and suggest the keyword or the category to the second client 120.

Alternatively, the advertisement content list may be arranged in order of popularity based on the frequency of selection for each advertiser. The advertisement content list may also be arranged in order of recency for each advertiser or based on each keyword. In addition, information about stores existing near a location included in the image content may be provided in order of nearest to farthest from the location with reference to metadata or location information of the image content.

The advertisement content list can also be arranged or filtered based on various other recommendation criteria or search criteria, so that the second client 120 can easily select advertisement content.

In FIGS. 15 through 17, a client screen 300 provided to the third client 130 is illustrated. The image content 221 posted by the second client 120 may be displayed on the client view provided to the third client 130. Although not illustrated in the drawings, various information may be provided in addition to the image content 221. The link mage 231 (e.g., a thumbnail image, a logo image, a trademark, etc.) may be displayed in an area of the image content 221.

The third client 130 may be naturally exposed to the link image 231 connected to the advertisement content while enjoying the image content 221 posted by the second client 120.

As described above, advertisement content or a link image that forms merged content may be confined to a predetermined portion or less of the entire area of image content.

When intending to access detailed information about the advertisement content, the third client 130 may click on the link image 231. When the third client 130 clicks on the link image 231, the image content 221 may be converted into the advertisement content 212 registered by the first client 110. Accordingly, detailed advertisement information may be provided to the third client 130.

More specifically, referring to FIGS. 18 and 19, when another user views merged content uploaded to a social network service, the link image 231 corresponding to advertisement content that has high relevance to the image content 221 may be merged with the image content 221 and exposed to other users. In the example illustrated in the drawings, the image content 221 is about a café, and a logo image 231 of the café is placed on a lower right side.

When an interested user clicks on a predetermined area, for example, the link image 231, part or whole of the image content 221 is converted into the advertisement content 212 and exposed to the user.

In this way, the entire advertisement content 212 is exposed only when a user who wants the advertisement content 212 clicks on the link image 231. This can eliminate an unnecessary feeling of repulsion and maximize advertising efficiency.

When the advertisement content 212 is exposed as described above, an advertising fee is incurred. Therefore, the first client 110 (i.e., an advertiser) may distribute the advertising fee between the server 200 which provides the service platform and the second client 120.

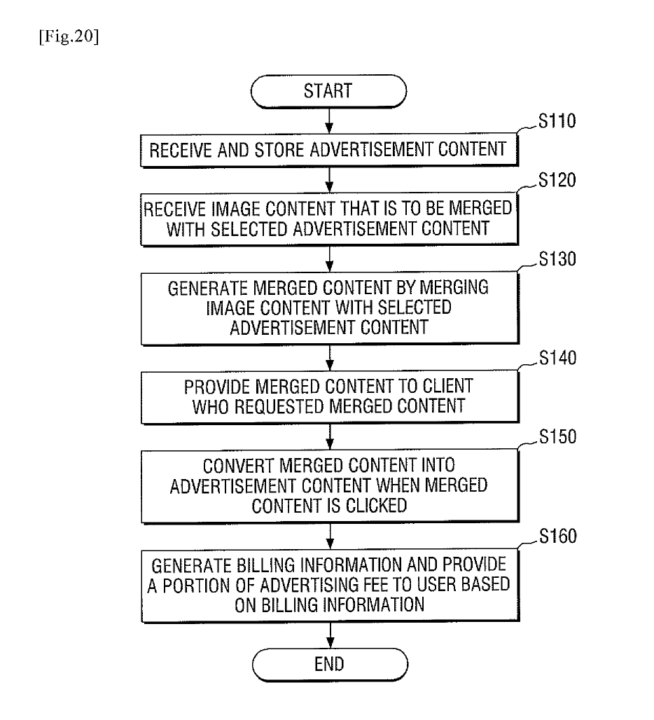

An online advertising method according to an embodiment of the present invention will now be described with reference to FIG. 20.

The online advertising method according to the current embodiment includes receiving and storing advertisement content (operation S110), receiving image content that is to be merged with advertisement content selected from the advertisement content (operation S120), generating merged content by merging the image content with the selected advertisement content (operation S130), and providing the merged content to a client who requested the merged content (operation S140).

The online advertising method according to the current embodiment may be substantially the same as the online advertising system described above. However, they are different in that the online advertising method is performed based on the server side.

First, advertisement content is received and stored (operation S110). A plurality of pieces of advertisement content may be received from a plurality of advertisers and managed and stored in a storage area of a server. Specifically, an advertisement content list including advertiser information, keyword information and tag information of the pieces of advertisement content may be generated.

Then, image content, which is to be merged with advertisement content selected by a user who intends to transmit the image content, is received (operation S120). Unlike conventional advertisements, the user himself or herself selects advertisement content that is to be merged with his or her image content.

In this process, the online advertising method may further include providing a list of recommended advertisement content arranged in order of relevance to the image content based on the advertisement content list by analyzing the image content.

Next, merged content is generated by merging the image content with the selected advertisement content (operation S130). The merged content may be converted into the advertisement content when a client clicks on a predetermined area of the merged content. A thumbnail image corresponding to the advertisement content may be generated and placed in the image content. In addition to the thumbnail image, a trademark or logo image of a product, an image of an advertiser, etc. may be placed. Here, the predetermined area may correspond to the thumbnail image.

The merged content may be provided to the client. When the client clicks on the predetermined area of the merged content, the merged content is converted into the advertisement content (operations S140 and S150).

When the advertisement content is exposed, billing information is generated by the server. A portion of an advertising fee incurred according to the billing information may be provided to the user who uploaded the image content (operation S160).

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims.

1. An online advertising system comprising:
a first client who provides advertisement content;
a server which receives and stores the advertisement content; and
a second client who provides image content to the server and selects the advertisement content that is to be merged with the image content,
wherein the server generates merged content by merging the image content with the advertisement content, provides the merged content to a third client, and converts the merged content into the advertisement content when the third client clicks on a predetermined area in the merged content.

2. The online advertising system of claim 1, wherein the server generates a thumbnail image corresponding to the advertising content, and the thumbnail image is placed in the image content to form the merged content.

3. The online advertising system of claim 2, wherein the predetermined area corresponds to an area in which the thumbnail image is placed.

4. The online advertising system of claim 1, wherein billing information is generated when the third client clicks on the predetermined area, and a portion of an advertising fee is provided from the first client to the second client based on the billing information.

5. The online advertising system of claim 1, wherein when storing the advertisement content, the server generates an advertisement content list comprising advertiser information, keyword information and tag information of the advertisement content.

6. The online advertising system of claim 5, wherein the second client selects the advertisement content that is to be merged with the image content by searching the advertisement content list.

7. The online advertising system of claim 5, wherein the server analyzes the image content and provides the second client with a list of recommended advertisement content arranged in order of relevance to the image content based on the advertisement content list.

8. The online advertising system of claim 1, wherein the server provides the first client with statistical data comprising the number of exposures of the advertisement content and the number of clicks on the merged content.

9. An online advertising system comprising:
a first client who provides advertisement content;
a server which receives and stores the advertisement content; and
a second client who provides image content to the server and selects the advertisement content that is to be merged with the image content,
wherein the server generates merged content by merging the image content with the advertisement content and provides the merged content to a third client, billing information is generated when the third client views the merged content, and a portion of an advertising fee is provided from the first client to the second client based on the billing information.

10. The online advertising system of claim 9, wherein the server generates a thumbnail image corresponding to the advertisement content, and the thumbnail image is placed in the image content to form the merged content.

11. The online advertising system of claim 10, wherein the merged content is converted into the advertisement content when the third client clicks on a predetermined area in the merged content.

12. The online advertising system of claim 9, wherein when storing the advertisement content, the server generates an advertisement content list comprising advertiser information, keyword information and tag information of the advertisement content.

13. The online advertising system of claim 12, wherein the second client selects the advertisement content that is to be merged with the image content by searching the advertisement content list.

14. The online advertising system of claim 12, wherein the server analyzes the image content and provides the second client with a list of recommended advertisement content arranged in order of relevance to the image content based on the advertisement content list.

15. The online advertising system of claim 9, wherein the server provides the first client with statistical data comprising the number of exposures of the advertisement content and the number of clicks on the merged content.

16. An online advertising method comprising:
receiving and storing advertisement content;
receiving image content that is to be merged with advertisement content selected from the advertisement content;
generating merged content by merging the image content with the selected advertisement content; and
providing the merged content to a client who requested the merged content.

17. The online advertising method of claim 16, wherein the merged content is converted into the advertisement content when the client clicks on a predetermined area of the merged content.

18. The online advertising method of claim 17, wherein the generating of the merged content comprises generating a thumbnail image corresponding to the advertisement content and placing the thumbnail image in the image content, wherein the predetermined area corresponds to the thumbnail image.

19. The online advertising method of claim 16, wherein the storing of the advertisement content comprises generating an advertisement content list comprising advertiser information, keyword information and tag information of the advertisement content.

20. The online advertising method of claim 19, further comprising analyzing the image content and providing a list of recommended advertisement content arranged in order of relevance to the image content based on the advertisement content list.
